(19) United States
(12) Patent Application Publication
(10) Pub. No.: US 2008/0062967 A1
(43) Pub. Date: Mar. 13, 2008

(54) VOIP DEVICE AND METHOD FOR PROCESSING DIAL STRINGS BY THE SAME

(75) Inventor: CHIEN-SHENG WU, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/608,809

(22) Filed: Dec. 9, 2006

(30) Foreign Application Priority Data
Aug. 23, 2006 (CN) 200610062243.3

(51) Int. Cl. H04L 12/66

(52) U.S. Cl. 370/352

(57) ABSTRACT

A voice over Internet protocol (VoIP) device (200) includes a receiving module (210) and a public switched telephone network (PSTN) processing module (220). The receiving module receives a dialed digit, and collects the dialed digit in a dial string. The PSTN processing module includes a PSTN redial determination sub-module (221), a PSTN prefix determination sub-module (222), and a PSTN redial sub-module (223). The PSTN redial determination sub-module determines whether a PSTN redial has started. The PSTN prefix determination sub-module determines whether a prefix matching the dial string is found in a PSTN redial table when the PSTN redial has not started. The PSTN redial sub-module redials the dial string to a PSTN when a prefix matching the dial string is found in the PSTN redial table. A method for processing dial strings by the same is also provided.

### BACKGROUND OF THE INVENTION

1. Field of the Invention

The invention relates to voice over Internet protocol (VoIP), and particularly to a VoIP device and a method for processing dial strings by the same.

2. Description of Related Art

With developments of communication technologies, several communication technologies provide different telephone communication services. The telephone communication services include a plain old telephone service (POTS), namely a public switched telephone network (PSTN) service, and a voice over Internet protocol (VoIP) service. The PSTN service is popular for standard telephone communications. When one telephone is coupled to a PSTN, the user of the telephone is served by the PSTN service for making a conventional call. VoIP is a protocol for transmitting voice and image packets through an open network to provide telephone communication service.

Nowadays, users often couple one telephone to a PSTN and a VoIP network via a VoIP gateway to acquire a PSTN service and a VoIP service at the same time. When users dial one string via the conventional VoIP gateway, the conventional VoIP gateway compares the dial string with phone numbers in a PSTN redial table and a VoIP digit map. The VoIP gateway redials the dial string to the PSTN when a phone number matching the dial string is found in the PSTN redial table. The VoIP gateway transmits the dial string to the VoIP network when a phone number matching the dial string is found in the VoIP digit map.

However, users need to wait for the PSTN redial of the VoIP gateway before starting communication when the users dial PSTN telephones via the conventional VoIP gateway. Thus, it is time-consuming for the users to wait for the PSTN redial of the conventional gateway.

### SUMMARY OF THE INVENTION

An exemplary embodiment of the present invention provides a voice over Internet protocol (VoIP) device. The VoIP device includes a receiving module and a public switched telephone network (PSTN) processing module. The receiving module receives a dialed digit, and collects the dialed digit in a dial string. The PSTN processing module includes a PSTN redial determination sub-module, a PSTN prefix determination sub-module, and a PSTN redial sub-module. The PSTN redial determination sub-module determines whether a PSTN redial has started. The PSTN prefix determination sub-module determines whether a prefix matching the dial string is found in a PSTN redial table when the PSTN redial has not started. The PSTN redial sub-module redials the dial string to a PSTN when a prefix matching the dial string is found in the PSTN redial table.

Another exemplary embodiment of the present invention provides a method for processing dial strings. The method includes the following steps. A dialed digit is received and collected in a dial string by a VoIP device. The VoIP device determines whether a public switched telephone network (PSTN) redial has started, and determines whether a prefix matching the dial string is found in a PSTN redial table if the PSTN redial has not started. The dial string is redialed to a PSTN if a prefix matching the dial string is found in the PSTN redial table.

Other advantages and novel features will become more apparent from the following detailed description when taken in conjunction with the accompanying drawings, in which:

### BRIEF DESCRIPTION OF THE DRAWINGS

FIG. 1 is a schematic diagram of a communication system of an exemplary embodiment of the present invention;

FIG. 2 is a schematic diagram of functional modules of a voice over Internet protocol (VoIP) device of another exemplary embodiment of the present invention; and

FIG. 3 is a flowchart of a method for processing dial strings of a further exemplary embodiment of the present invention.

### DETAILED DESCRIPTION OF THE INVENTION

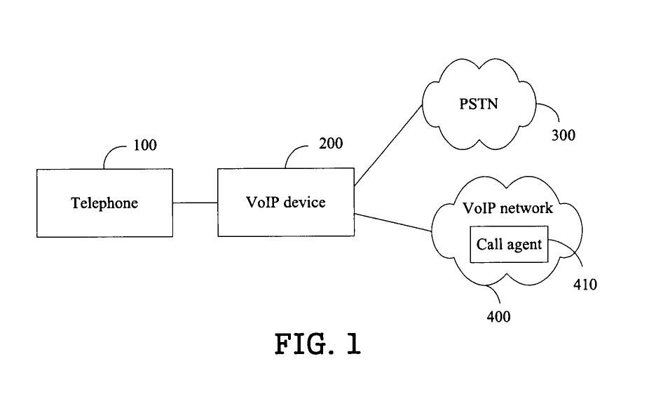

FIG. 1 is a schematic diagram of a communication system of an exemplary embodiment of the present invention. In the exemplary embodiment, the communication system includes a telephone 100, a phone service device or a voice over Internet protocol (VoIP) device 200, a public switched telephone network (PSTN) 300, and a VoIP network 400. A call agent (CA) 410 is disposed in the VoIP network 400, for controlling the VoIP device 200. For example, the call agent 410 configures a VoIP digit map and stores the VoIP digit map in the VoIP device 200.

In the exemplary embodiment, the phone service device or the VoIP device 200 may be a VoIP gateway, an asymmetric digital subscriber line (ADSL) modem, or a wireless access point. The telephone 100 can route a phone number to the PSTN 300 or the VoIP network 400 via the VoIP device 200.

In the exemplary embodiment, the VoIP device 200 initially receives a dialed digit from the telephone 100, collects the dialed digit in a dial string, and then determines whether a PSTN redial has started. If the PSTN redial has not started, the VoIP device 200 further determines whether a prefix matching the dial string is found in a PSTN redial table. If a prefix matching the dial string is found in the PSTN redial table, the VoIP device 200 redials the dial string to the PSTN 300. Therefore, time for PSTN redialing is effectively reduced, and accordingly time for users to wait is reduced.

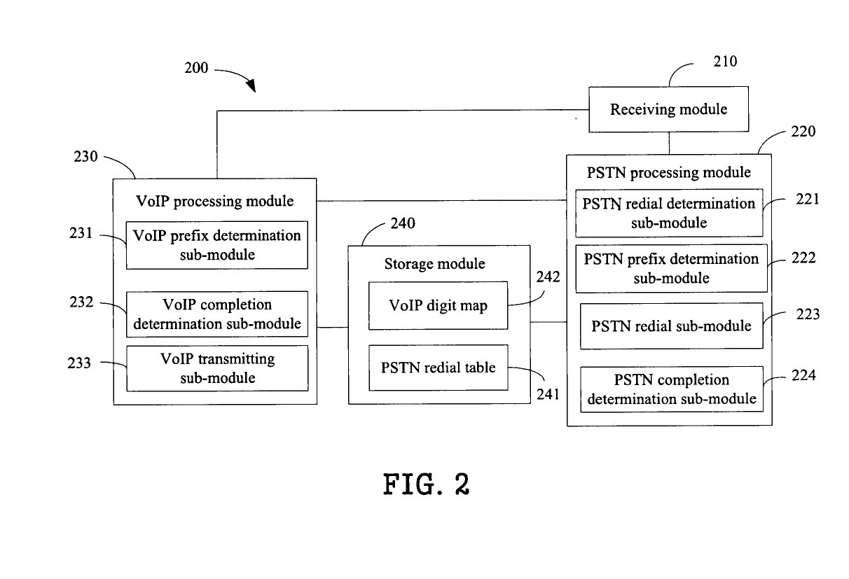

FIG. 2 is a schematic diagram of functional modules of the VoIP device 200 of an exemplary embodiment of the present invention. In the exemplary embodiment, the VoIP device 200 includes a receiving module 210, a PSTN processing module 220, a VoIP processing module 230, and a storage module 240.

The storage module 240 includes a PSTN redial table 241 and a VoIP digit map 242. In the exemplary embodiment, the PSTN redial table 241 can be configured manually, and stored in the storage module 240. The VoIP digit map 242 is configured by the call agent 410, and stored in the storage module 240.

The PSTN redial table 241 includes a plurality of PSTN dial entries. Each PSTN dial entry includes a prefix and a length, for defining a plurality of PSTN phone numbers. The prefix of the PSTN dial entry indicates a prefix of the defined PSTN phone numbers, and the length of the PSTN dial entry indicates a length of the defined PSTN phone numbers. In the exemplary embodiment, the length of the PSTN dial entry may be a non-zero digit, indicating a length of the defined PSTN phone numbers is equal to the non-zero digit. The length of the PSTN dial entry may be a zero digit, indicating a length of the defined PSTN phone numbers is indefinite.

The VoIP digit map 242 includes a plurality of VoIP dial entries. Each VoIP dial entry includes a prefix and a length, for defining a plurality of VoIP phone numbers. The prefix of the VoIP dial entry indicates a prefix of the defined VoIP phone numbers, and the length of the VoIP dial entry indicates a length of the defined VoIP phone numbers. In the exemplary embodiment, the length of the VoIP dial entry may be a non-zero digit, indicating a length of the defined VoIP phone numbers is equal to the non-zero digit. The length of the VoIP dial entry may be a zero digit, indicating a length of the defined VoIP phone numbers is indefinite.

The receiving module 210 receives a dialed digit, and collects the dialed digit in a dial string. The PSTN processing module 220, for processing the dial string, includes a PSTN redial determination sub-module 221, a PSTN prefix determination sub-module 222, a PSTN redial sub-module 223, and a PSTN completion determination sub-module 224.

The PSTN redial determination sub-module 221 determines whether a PSTN redial has started. In the exemplary embodiment, the PSTN processing module 220 sets a PSTN flag to represent whether the PSTN redial has started. The PSTN redial determination sub-module 221 determines whether the PSTN redial has started according to how the PSTN flag is set. For example, if the PSTN flag is set to 1, the PSTN redial has started. If the PSTN flag is set to 0, the PSTN redial has not started.

The PSTN prefix determination sub-module 222 determines whether a prefix matching the dial string is found in the PSTN redial table 241 when the PSTN redial has not started. In the exemplary embodiment, the PSTN prefix determination sub-module 222 compares the dial string with a prefix of each dial entry in the PSTN redial table 241 to determine whether a prefix matching the dial string is found in the PSTN redial table 241.

The PSTN redial sub-module 223 redials the dial string to the PSTN 300 when a prefix matching the dial string is found in the PSTN redial table 241. In the exemplary embodiment, when redialing the dial string to the PSTN 300, the PSTN redial sub-module 223 further sets the PSTN flag to 1.

When the PSTN redial has started, the PSTN redial sub-module 223 further redials the dialed digit to the PSTN 300.

The PSNT completion determination sub-module 224 determines whether the dial string is a complete PSTN phone number. In the exemplary embodiment, the PSTN completion determination sub-module 224 determines whether the dial string is a complete PSTN phone number according to a length of the dial string or according to whether a dial time has elapsed. In this embodiment, if a length of a PSTN dial entry matching the dial string in the PSTN redial table 241 is a non-zero digit, the PSTN completion determination sub-module 224 determines whether the dial string is a complete PSTN phone number according to the length of the dial string. If the length of the dial string is equal to the non-zero digit, the dial string is a complete PSTN phone number. If the length of the dial string is not equal to the non-zero digit, the dial string is not a complete PSTN phone number.

If the length of a PSTN dial entry matching the dial string in the PSTN redial table 241 is a zero digit, the PSTN completion determination sub-module 224 determines whether the dial string is a complete PSTN phone number according to whether the dial time has elapsed. If the dial time has elapsed, the dial string is a complete PSTN phone number. If the dial time has not elapsed, the dial string is not a complete PSTN phone number. For example, if a next dialed digit is not received within a certain period of time such as 3 seconds after the VoIP device 200 receives one dialed digit, the PSTN completion determination sub-module 224 determines that the dial time has elapsed, thereby determining that the dial string is a complete PSTN phone number. If a next dialed digit is received within 3 seconds after the VoIP device 200 receives one dialed digit, the PSTN completion determination sub-module 224 determines that the dial time has not elapsed, thereby determining that the dial string is not a complete PSTN phone number.

In the exemplary embodiment, the PSTN completion determination sub-module 224 determines whether the dial string is a complete PSTN phone number after the PSTN redial sub-module 223 redials the dialed digit or the dial string to the PSTN 300. If the dial string is a complete PSTN phone number, the PSTN redial is ended. If the dial string is not a complete PSTN phone number, the receiving module 210 goes on receiving another dialed digit and collecting the dialed digit in the dial string.

The VoIP processing module 230, for processing the dial string, includes a VoIP prefix determination sub-module 231, a VoIP completion determination sub-module 232, and a VoIP transmitting sub-module 233.

The VoIP prefix determination sub-module 231 determines whether a prefix matching the dial string is found in the VoIP digit map 242 when no prefix matching the dial string is found in the PSTN redial table 241. In the exemplary embodiment, the VoIP prefix determination sub-module 231 compares the dial string with a prefix of each dial entry in the VoIP digit map 242 to determine whether a prefix matching the dial string is found in the VoIP digit map 242.

When no prefix matching the dial string is found in the VoIP digit map 242, the receiving module 210 goes on receiving another dialed digit and collecting the dialed digit in the dial string.

The VoIP completion determination sub-module 232 determines whether the dial string is a complete VoIP phone number when a prefix matching the dial string is found in the VoIP digit map 242. In the exemplary embodiment, the VoIP completion determination sub-module 232 determines whether the dial string is a complete VoIP phone number according to a length of the dial string or according to whether the dial time has elapsed. In this embodiment, if a length of a VoIP dial entry matching the dial string in the VoIP digit map 242 is a non-zero digit, the VoIP completion determination sub-module 232 determines whether the dial string is a complete VoIP phone number according to the length of the dial string. If the length of the dial string is equal to the non-zero digit, the dial string is a complete VoIP phone number. If the length of the dial string is not equal to the non-zero digit, the dial string is not a complete VoIP phone number.

If the length of a VoIP dial entry matching the dial string in the VoIP digit map 242 is a zero digit, the VoIP completion determination sub-module 232 determines whether the dial string is a complete VoIP phone number according to whether the dial time has elapsed. If the dial time has elapsed, the dial string is a complete VoIP phone number. If the dial time has not elapsed, the dial string is not a complete VoIP phone number.

When the dial string is not a complete VoIP phone number, the receiving module 210 goes on receiving another dialed digit and collecting the dialed digit in the dial string.

The VoIP transmitting sub-module 233 transmits the dial string to the VoIP network 400 when the dial string is a complete VoIP dial phone number.

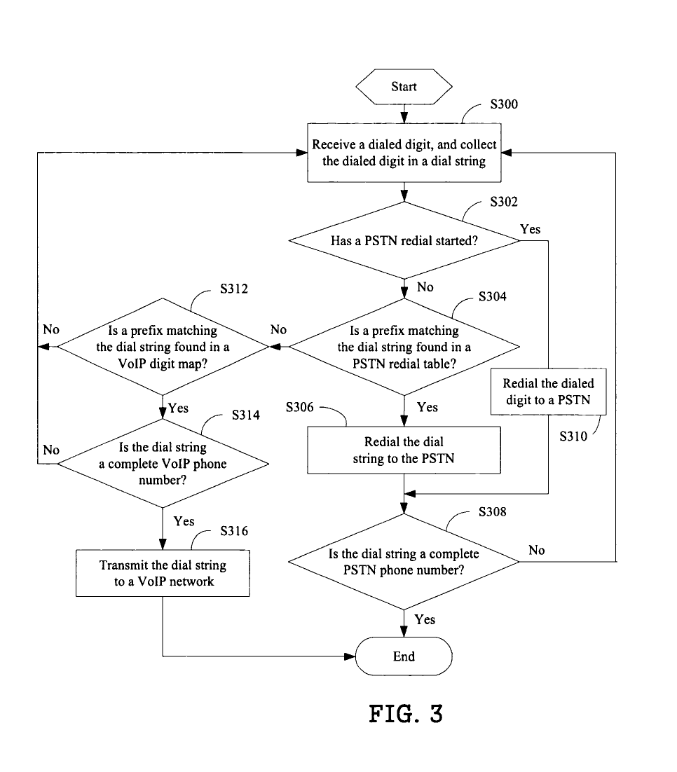

FIG. 3 is a flowchart of a method for processing dial strings of an exemplary embodiment of the present invention. The method is defined to comprise at least a step of retrieving an identifiable prefix from a dial string which is system-defined to save or collect any dialed digit from a telephone one by one, and another step of redialing a next-received dialed digit immediately without delay when the prefix is identified as in the PSTN redial table 241, i.e., after identification of the complete prefix, the rest and later received digits in the dial string will be redialed right away one by one. The conventionally possible wait time for waiting the rest digits in the dial string before redialing can therefore be saved.

In detail, in step S300, the receiving module 210 of the VoIP device 200 receives a dialed digit, and collects the dialed digit in a dial string.

In step S302, the PSTN redial determination sub-module 221 determines whether a PSTN redial has started. In the exemplary embodiment, the PSTN processing module 220 sets a PSTN flag to represent whether the PSTN redial has started. The PSTN redial determination sub-module 221 determines whether the PSTN redial has started according to how the PSTN flag is set. For example, if the PSTN flag is set to 1, the PSTN redial has started. If the PSTN flag is set to 0, the PSTN redial has not started.

If the PSTN redial has started, in step S310, the PSTN redial sub-module 223 redials the dialed digit to the PSTN 300.

If the PSTN redial has not started, in step S304, the PSTN prefix determination sub-module 222 determines whether a prefix matching the dial string is found in the PSTN redial table 241. In the exemplary embodiment, the PSTN prefix determination sub-module 222 compares the dial string with the prefix of each dial entry in the PSTN redial table 241 to determine whether a prefix matching the dial string is found in the PSTN redial table 241.

If no prefix matching the dial string is found in the PSTN redial table 241, in step S312, the VoIP prefix determination sub-module 231 determines whether a prefix matching the dial string is found in the VoIP digit map 242.

If a prefix matching the dial string is found in the PSTN redial table 241, in step S306, the PSTN redial sub-module 223 redials the dial string to the PSTN 300. In the exemplary embodiment, when redialing the dial string to the PSTN 300, the PSTN redial sub-module 223 further sets the PSTN flag to 1.

In step S308, the PSNT completion determination sub-module 224 determines whether the dial string is a complete PSTN phone number. In the exemplary embodiment, the PSTN completion determination sub-module 224 determines whether the dial string is a complete PSTN phone number according to a length of the dial string or according to whether a dial time has elapsed. In this embodiment, if a length of a PSTN dial entry matching the dial string in the PSTN redial table 241 is a non-zero digit, the PSTN completion determination sub-module 224 determines whether the dial string is a complete PSTN phone number according to the length of the dial string. If the length of the dial string is equal to the non-zero digit, the dial string is a complete PSTN phone number. If the length of the dial string is not equal to the non-zero digit, the dial string is not a complete PSTN phone number.

If the length of a PSTN dial entry matching the dial string in the PSTN redial table 241 is a zero digit, the PSTN completion determination sub-module 224 determines whether the dial string is a complete PSTN phone number according to whether the dial time has elapsed. If the dial time has elapsed, the dial string is a complete PSTN phone number. If the dial time has not elapsed, the dial string is not a complete PSTN phone number.

If the dial string is a complete PSTN phone number, the PSTN redial is ended.

If the dial string is not a complete PSTN phone number, going back to step S300, the receiving module 210 goes on receiving another dialed digit and collecting the dialed digit in the dial string.

In step S312, when no prefix matching the dial string is found in the PSTN redial table 241, the VoIP prefix determination sub-module 231 compares the dial string with a prefix of each dial entry in the VoIP digit map 242 to determine whether a prefix matching the dial string is found in the VoIP digit map 242.

If no prefix matching the dial string is found in the VoIP digit map 242, returning to step S300, the receiving module 210 goes on receiving another dialed digit and collecting the dialed digit in the dial string.

If a prefix matching the dial string is found in the VoIP digit map 242, the VoIP completion determination sub-module 232 determines whether the dial string is a complete VoIP phone number. In the exemplary embodiment, the VoIP completion determination sub-module 232 determines whether the dial string is a complete VoIP phone number according to a length of the dial string or according to whether the dial time has elapsed. In this embodiment, if a length of a PSTN dial entry matching the dial string in the VoIP digit map 242 is a non-zero digit, the VoIP completion determination sub-module 232 determines whether the dial string is a complete VoIP phone number according to the length of the dial string. If the length of the dial string is equal to the non-zero digit, the dial string is a complete VoIP phone number. If the length of the dial string is not equal to the non-zero digit, the dial string is not a complete VoIP phone number.

If the length of a VoIP dial entry matching the dial string in the VoIP digit map 242 is a zero digit, the VoIP completion determination sub-module 232 determines whether the dial string is a complete VoIP phone number according to whether the dial time has elapsed. If the dial time has elapsed, the dial string is a complete VoIP phone number. If the dial time has not elapsed, the dial string is not a complete VoIP phone number.

If the dial string is a complete VoIP phone number, in step S316, the VoIP transmitting sub-module 233 transmits the dial string to the VoIP network 400.

If the dial string is not a complete VoIP phone number, going back to step S300, the receiving module 210 goes on receiving another dialed digit and collecting the dialed digit in the dial string.

In the exemplary embodiment of the present invention, the VoIP device 200 redials a dial string to the PSTN 300 when a prefix matching the dial string is found in the PSTN redial table 241 without comparing the length of the dial string. Thus, time for PSTN redialing is reduced, and accordingly time for uses to wait is reduced.

While various embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A voice over Internet protocol (VoIP) device comprising:
a receiving module, for receiving a dialed digit and collecting the dialed digit in a dial string; and
a public switched telephone network (PSTN) processing module, comprising:
a PSTN redial determination sub-module, for determining whether a PSTN redial has started;
a PSTN prefix determination sub-module, for determining whether a prefix matching the dial string is found in a PSTN redial table when the PSTN redial has not started; and
a PSTN redial sub-module, for redialing the dial string to a PSTN when a prefix matching the dial string is found in the PSTN redial table.

2. The VoIP device as claimed in claim 1, further comprising a storage module for storing the PSTN redial table, configured manually; the PSTN redial table comprises a plurality of PSTN dial entries, and each PSTN dial entry comprises a prefix and a length.

3. The VoIP device as claimed in claim 2, wherein the storage module further stores a VoIP digit map, configured by a call agent; the VoIP digit map comprises a plurality of VoIP dial entries, and each VoIP dial entry comprises a prefix and a length.

4. The VoIP device as claimed in claim 3, further comprising a VoIP processing module for processing the dial string, the VoIP processing module comprising:
a VoIP prefix determination sub-module, for determining whether a prefix matching the dial string is found in the VoIP digit map when no prefix matching the dial string is found in the PSTN redial table;
a VoIP completion determination sub-module, for determining whether the dial string is a complete VoIP phone number when a prefix matching the dial string is found in the VoIP digit map; and
a transmitting sub-module, for transmitting the dial string to a VoIP network when the dial string is a complete VoIP phone number.

5. The VoIP device as claimed in claim 1, wherein the PSTN redial determination sub-module determines whether the PSTN redial has started according to how a PSTN flag is set.

6. The VoIP device as claimed in claim 1, further comprising a PSTN completion determination sub-module, for determining whether the dial string is a complete PSTN phone number.

7. The VoIP device as claimed in claim 6, wherein the PSTN completion determination sub-module determines whether the dial string is a complete PSTN phone number according to a length of the dial string or according to whether a dial time has elapsed.

8. The VoIP device as claimed in claim 1, wherein the PSTN redial sub-module further redials the dialed digit to the PSTN when the PSTN redial has started.

9. A method for processing dial strings, comprising:
receiving a dialed digit and collecting the dialed digit in a dial string;
determining whether a public switched telephone network (PSTN) redial has started;
determining whether a prefix matching the dial string is found in a PSTN redial table if the PSTN redial has not started; and
redialing the dial string to a PSTN if a prefix matching the dial string is found in the PSTN redial table.

10. The method for processing dial strings as claimed in claim 9, wherein the PSTN redial table, configured manually, comprises a plurality of PSTN dial entries, and each PSTN dial entry comprises a prefix and a length.

11. The method for processing dial strings as claimed in claim 9, further comprising:
determining whether a prefix matching the dial string is found in a voice over Internet protocol (VoIP) digit map if no prefix matching the dial string is found in the PSTN redial table;
determining whether the dial string is a complete VoIP phone number if a prefix matching the dial strings is found in the VoIP digit map; and
transmitting the dial string to a VoIP network if the dial string is a complete VoIP phone number.

12. The method for processing dial strings as claimed in claim 11, wherein the VoIP digit map, configured by a call agent, comprises a plurality of VoIP dial entries, and each VoIP dial entry comprises a prefix and a length.

13. The method for processing dial strings as claimed in claim 9, further comprising:
redialing the dialed digit to the PSTN if the PSTN redial has started.

14. The method for processing dial strings as claimed in claim 9, wherein the step of determining whether the PSTN redial has started comprises:
determining whether the PSTN redial has started according to how a PSTN flag is set.

15. The method for processing dial strings as claimed in claim 9, further comprising:
determining whether the dial string is a complete PSTN phone number; and
go on receiving another dialed digit and collecting the dialed digit in the dial string if the dial string is not a complete PSTN phone number.

16. A method for processing dial strings in a phone service device, comprising steps of:
receiving at least one dialed digit from a telephone in a predefined dial string;
retrieving an identifiable prefix from said dial string including said received at least one dialed digit; and
redialing a next-received dialed digit to be included in said dial string when said retrieved prefix is identified to indicate that said dial string needs to redial for further available telephone service.

17. The method as claimed in claim 16, wherein said telephone service is a public switched telephone network (PSTN) service.
